(19) United States
(12) Patent Application Publication
(10) Pub. No.: US 2024/0410998 A1
(43) Pub. Date: Dec. 12, 2024

(54) CONTROL METHOD AND CONTROL SYSTEM FOR LIGHT EMISSION OF LIGHT SOURCE AND LIDAR

(71) Applicant: HESAI TECHNOLOGY CO., LTD., Shanghai (CN)

(72) Inventors: Zhaoyu LU, Shanghai (CN); Zhengqing PAN, Shanghai (CN); Jianhao MAO, Shanghai (CN); Shaoqing XIANG, Shanghai (CN)

(21) Appl. No.: 18/750,500

(22) Filed: Jun. 21, 2024

Related U.S. Application Data
(63) Continuation of application No. PCT/CN2022/097727, filed on Jun. 8, 2022.

(30) Foreign Application Priority Data
Dec. 23, 2021 (CN) 202111594490.9

(51) Int. Cl. G01S 7/4911; G01S 7/481; G01S 7/4915; G01S 17/58

(52) U.S. Cl. CPC G01S 7/4911; G01S 7/4814; G01S 7/4816; G01S 7/4818; G01S 7/4915; G01S 17/58

(57) ABSTRACT

A method of controlling light emission for a light source includes determining a drive signal for driving the light source to output an optical signal, wherein determining the drive signal includes superposing a value of a pre-corrected modulation curve and an integral value of an integrator; determining a difference frequency signal by performing frequency beating on the optical signal and a delayed optical signal; and updating the integral value by determining phase discrimination data based on the difference frequency signal and a predetermined reference signal, and performing integration on the phase discrimination data.

### CROSS-REFERENCE TO RELATED APPLICATIONS

This application is a continuation of International Application No. PCT/CN2022/097727, filed on Jun. 8, 2022, which claims priority to Chinese Patent Application No. 202111594490.9, filed on Dec. 23, 2021, the content of both of which is hereby incorporated by reference in their entireties.

### TECHNICAL FIELD

This disclosure relates to the field of light source control technologies, and in particular to light emission control methods for a light source, control systems, and LiDARs.

### BACKGROUND

Frequency Modulated Continuous Wave (“FMCW”) laser detection is a high-precision detection technology based on the principle of coherent detection. For example, with reference to a schematic structural diagram of a LiDAR shown in FIG. 1, a light source 11 can generate high-frequency frequency modulated light. A part of the frequency modulated light can be amplified by an optical splitter (not shown in FIG. 1) and transmitted to a transmitting end 12, and then transmitted to a target space. Echo light reflected by an obstacle 1A can be received by a LiDAR receiver 14. The other part of the frequency modulated light can be used as local oscillator light and is coupled to a frequency mixer 13. The frequency mixer 13 can mix and filter the local oscillator light and the echo light received by the radar receiver 14. After mixing and filtering, a detector 15 can determine a difference frequency signal. The difference frequency signal can be transmitted by a sampler 16 (such as an analog-to-digital converter) to a signal processor 17 for processing. Based on the difference frequency signal between the echo light and the local oscillator light, the distance and speed information of the obstacle can be determined.

When a laser signal emitted by the light source is a linear frequency modulated signal (e.g., a triangle wave), after frequency beating is performed on the echo signal with a particular delay and the local oscillator signal (i.e., a reference wave), a frequency difference between the rising edge of the echo signal and the rising edge of the local oscillator signal, and a frequency difference between the falling edge of the echo signal and the falling edge of the local oscillator signal can be determined. In the absence of Doppler frequency shift, the frequency differences at the rising edge and the falling edge can be the same. Therefore, in the absence of the Doppler frequency shift, the frequency beating can be performed on the signal with only time (or phase) delay (i.e., delayed wave) and the reference wave, and a frequency beaten signal can be determined. By measuring whether the frequency of the frequency beaten signal is constant, it can be determined whether the signal is in a stable linear sweep-frequency state. In a schematic diagram of the frequency-time (“f-t”) relationship of FMCW as shown in FIG. 2, a difference between frequencies of a reference wave Wr and a delayed wave We is the frequency f0 of a frequency beaten signal Wb, and when there is no Doppler frequency shift, the frequency differences between the reference wave Wr and the delayed wave We at the rising edge and the falling edge can be the same.

The light source, driven by the drive signal, can generate frequency modulated continuous light. The frequency modulated continuous light can be linear frequency modulated light in an ideal state. However, under the influence of factors such as nonlinearity of a light source response, jitter or deviation can occur, and an output optical signal can produce some nonlinear frequency sweeps. Then, the frequency of the detected echo signal and the frequency of the output optical signal deviate. To improve the accuracy of target detection, the output optical frequency of the light source is needed to be corrected and controlled.

Existing solutions for correcting and controlling the output light frequency of the light source need complex circuit or chip design, resulting in high system complexity and increased cost.

### SUMMARY

In view of this, the embodiments of this specification provide light emission control methods for a light source, control systems, and LiDARs, which can reduce system complexity and thus reduce implementation costs.

First, the embodiments of this disclosure provide a light emission control method for a light source, including: superposing a value of a pre-configured pre-corrected modulation curve and an integral value of an integrator to determine a digital drive signal, and determining an analog drive signal based on the digital drive signal to drive the light source to output an optical signal; obtaining a difference frequency signal determined by performing frequency beating on the optical signal and a delayed optical signal; determining a difference frequency square signal based on the difference frequency signal; and performing phase discrimination and comparison on the difference frequency square signal with a predetermined reference square signal, and performing integrating processing on the phase discrimination result to determine the integral value.

Optionally, the acquiring the difference frequency signal determined by performing frequency beating on the optical signal and a delayed optical signal includes: obtaining the difference frequency optical signal determined by performing frequency beating on the optical signal and the delayed optical signal; and determining a difference frequency voltage signal based on the difference frequency optical signal.

Optionally, the determining the difference frequency square signal based on the difference frequency signal includes: collecting the difference frequency voltage signal by using an analog-to-digital converter to determine a difference frequency voltage digital signal; and comparing the difference frequency voltage digital signal with a predetermined reference value by using a comparator, and outputting the difference frequency square signal.

Optionally, the determining the difference frequency square signal based on the difference frequency signal includes: determining the difference frequency square signal based on the difference frequency voltage signal by using a Schmitt trigger.

Optionally, the pre-corrected modulation curve is configured to enable the light source to output a linear frequency modulated optical signal.

Accordingly, the embodiments of this disclosure provide a light emission control system for a light source, coupled to the light source, and including: an optical interference processor module, an analog-to-digital converter module, a digital logic processor module, and a digital-to-analog converter module.

The digital-to-analog converter module is configured to determine an analog drive signal based on a digital drive signal output by the digital logic processor module to drive the light source to output an optical signal.

The optical interference processor module is configured to delay the optical signal, and perform frequency beating on the optical signal and the delayed optical signal to determine a difference frequency signal.

The analog-to-digital converter module is configured to determine a difference frequency square signal based on the difference frequency signal.

The digital logic processor module is configured to superpose a pre-configured pre-corrected modulation curve and an integral value of an integrator to determine the digital drive signal, and perform phase discrimination and comparison on the difference frequency square signal with a predetermined reference square signal, and perform integrating processing on the phase discrimination result to determine the integral value.

Optionally, the digital logic processor module includes: a first memory configured to store the reference square signal; a second memory configured to store the pre-corrected modulation curve of the light source; a digital phase frequency detector configured to perform phase discrimination and comparison on the difference frequency square signal with the reference square signal stored in the first memory, and output the phase discrimination result; the integrator configured to perform integrating processing on the phase discrimination result output by the digital phase frequency detector to determine the integral value; and an adder configured to superpose the integral value and a value of the pre-corrected modulation curve stored in the second memory to determine the digital drive signal.

Optionally, the optical interference processor module outputs a difference frequency optical signal, and the light emission control system further includes: a photon detector module configured to receive the difference frequency optical signal output by the optical interference processor module, and determine a difference frequency voltage signal based on the difference frequency optical signal.

Optionally, the photon detector module includes: a photon detector configured to determine a difference frequency current signal based on the difference frequency optical signal; and a trans-impedance amplifier configured to perform signal amplification processing on the difference frequency current signal and determine the difference frequency voltage signal based on the difference frequency current signal.

Optionally, the analog-to-digital converter module includes: an analog-to-digital converter configured to collect the difference frequency voltage signal to determine a difference frequency voltage digital signal; and a comparator configured to compare the difference frequency voltage digital signal with a predetermined reference value, and output the difference frequency square signal.

Optionally, the analog-to-digital converter module includes: an analog-to-digital converter configured to collect the difference frequency voltage signal to determine a difference frequency voltage digital signal; and the digital logic processor module further includes: a comparator configured to compare the difference frequency voltage digital signal with the predetermined reference value, and output the difference frequency square signal.

Optionally, the analog-to-digital converter module includes: a Schmitt trigger configured to determine the difference frequency square signal based on the difference frequency voltage signal.

Optionally, the digital logic processor module is a programmable logic device.

Optionally, the pre-corrected modulation curve is configured to enable the light source to output a linear frequency modulated optical signal.

Accordingly, the embodiments of this disclosure further provide another light emission control system for a light source, coupled to the light source, and including: an optical interference processor module, an analog-to-digital converter module, a first memory, a second memory, a digital phase frequency detector, an integrator, an adder, and a digital-to-analog converter module.

The digital-to-analog converter module is configured to determine an analog drive signal based on a digital drive signal output by the adder to drive the light source to output an optical signal.

The optical interference processor module is configured to perform frequency beating on the optical signal and a delayed optical signal to determine a difference frequency signal.

The analog-to-digital converter module is configured to determine a difference frequency square signal based on the difference frequency signal.

The first memory is configured to store a reference square signal.

The second memory is configured to store a pre-corrected modulation curve of the light source.

The digital phase frequency detector is configured to perform phase discrimination and comparison on the difference frequency square signal with the reference square signal stored in the first memory, and output the phase discrimination result;

The integrator is configured to perform integrating processing on the phase discrimination result output by the digital phase frequency detector to determine the integral value.

The adder is configured to superpose a value of the pre-corrected modulation curve pre-configured by the second memory and the integral value to determine the digital drive signal.

The embodiments of this disclosure further provide a LiDAR, including a light source, an optical interference processor module, an analog-to-digital converter module, a digital logic processor module, and a digital-to-analog converter module.

The light source is configured to output an optical signal. The digital-to-analog converter module is configured to determine an analog drive signal based on a digital drive signal output by the digital logic processor module. The optical interference processor module is configured to perform frequency beating on the optical signal and a delayed optical signal to determine a difference frequency signal. The analog-to-digital converter module is configured to determine a difference frequency square signal based on the difference frequency signal. The digital logic processor module is configured to superpose a value of a pre-configured pre-corrected modulation curve and an integral value to determine the digital drive signal, and perform phase discrimination and comparison on the difference frequency square signal with a predetermined reference square signal, and perform integrating processing on the phase discrimination result to determine the integral value.

Optionally, the light source includes a distributed feedback laser.

Optionally, the optical interference processor module includes a fiber interferometer with unequal arm lengths.

In some embodiments of this disclosure, the digital drive signal can be determined by superposing the value of the pre-configured pre-corrected modulation curve and the integral value of the integrator, and the analog drive signal can be determined based on the digital drive signal to drive the light source to output the optical signal. By obtaining the difference frequency signal determined by performing frequency beating on the optical signal and the delayed optical signal, and determining a difference frequency square signal based on the difference frequency signal, then phase discrimination and comparison can be performed on the difference frequency square signal and the predetermined reference square signal, and integrating processing can be performed on the phase discrimination result to determine the integral value. The integral value can be used for correcting and controlling the optical signal output by the light source in real time. In this correction and control process, the optical signal output by the light source can be corrected by performing phase discrimination and comparison on the difference frequency signal determined based on the optical signal output by the light source with the predetermined reference square signal, and performing integrating processing on the phase discrimination result, and superposing the determined integral value and the value of the pre-corrected modulation curve. In this way, the optical signal output by the light source can be corrected to realize the light emission control of the light source without the need for complicated circuit or chip design. The system complexity and implementation costs can be reduced.

In some embodiments of this disclosure, the digital logic processor module can superpose the value of the pre-configured pre-corrected modulation curve and the integral value of the integrator to determine the digital drive signal. The corresponding analog drive signal can be determined based on the digital drive signal by the digital-to-analog converter to drive the light source to output the optical signal to the optical interference processor module. The optical interference processor module can delay the optical signal and perform frequency beating on the delayed optical signal and the optical signal to determine the corresponding difference frequency signal. The analog-to-digital converter module determines the difference frequency square signal based on the difference frequency signal and outputs the difference frequency square signal to the digital logic processor module. The digital logic processor module can perform phase discrimination and comparison on the difference frequency square signal with the predetermined reference square signal, and perform integrating processing on the determined phase discrimination result to determine the integral value. The integral value determined by the feedback can be used for performing real-time correction and control on the optical signal output by the light source. Using this light emission control system, the optical signal output by the light source can be corrected by the digital logic processor module. The digital logic processor module can perform phase discrimination and comparison on the difference frequency signal determined based on the optical signal output by the light source with the predetermined reference square signal, and perform integrating processing on the phase discrimination result, and superpose the determined integral value and the value of the pre-corrected modulation curve. In this way, the optical signal output by the light source can be corrected to realize the light emission control of the light source without the need for complicated circuit or chip design. The system complexity and implementation costs can be reduced.

Further, the digital logic processor module includes a first memory, a second memory, a digital phase frequency detector, the integrator, and an adder. Phase discrimination and comparison can be performed on the reference square signal stored in the first memory with the difference frequency square signal by the phase frequency detector, and the determined phase discrimination result can be integrated by the integrator. The adder can superpose the determined integral value and the value of the pre-corrected curve stored in the second memory to determine the digital drive signal that can drive the light source to emit light. Accordingly, the digital logic processor module including the first memory, the second memory, the integrator, the adder, and the digital phase frequency detector can be used. On the one hand, the volume of the entire light emission control system for a light source can be reduced while realizing the light emission control of the light source. On the other hand, the time delay between signals of various devices can be reduced and the response speed of the light emission control system for a light source can be improved.

Furthermore, a Schmitt trigger can directly determine the difference frequency square signal based on the difference frequency voltage signal without multiple conversions. In such a case, the time delay between the signals of various devices in the system can be reduced and the response speed of the system can be improved, and further the volume of the entire light emission control system can be reduced.

### DESCRIPTION OF THE DRAWINGS

To describe the technical solutions in the embodiments of this disclosure or in the related art more clearly, the following briefly introduces the accompanying drawings for describing the embodiments or the related art. Apparently, the accompanying drawings in the following description show merely the embodiments of this disclosure, and a person of ordinary skill in the art can still derive other drawings from the provided accompanying drawings without creative efforts.

FIG. 1 shows a schematic structural diagram of a LiDAR.

FIG. 2 shows a schematic diagram of a frequency-time relationship of FMCW.

FIG. 3 shows a flowchart of an example light emission control method for a light source, consistent with some embodiments of this disclosure.

FIG. 4 shows a schematic structural diagram of an example light emission control system for a light source, consistent with some embodiments of this disclosure.

FIG. 5 shows a schematic structural diagram of an example digital logic processor module, consistent with some embodiments of this disclosure.

FIG. 6 shows a schematic structural diagram of an example optical interference processor module, consistent with some embodiments of this disclosure.

FIG. 7 shows a schematic structural diagram of a first example light emission control system for a light source, consistent with some embodiments of this disclosure.

FIG. 8 shows an example waveform diagram of a corresponding output signal of FIG. 7, consistent with some embodiments of this disclosure.

FIG. 9 shows a schematic structural diagram of a second example light emission control system for a light source, consistent with some embodiments of this disclosure.

FIG. 10 shows a schematic structural diagram of a third example light emission control system for a light source, consistent with some embodiments of this disclosure.

FIG. 11 shows a schematic structural diagram of a fourth example light emission control system for a light source, consistent with some embodiments of this disclosure.

FIG. 12 shows a schematic structural diagram of a first example LiDAR, consistent with some embodiments of this disclosure.

FIG. 13 shows a schematic structural diagram of a second example LiDAR, consistent with some embodiments of this disclosure.

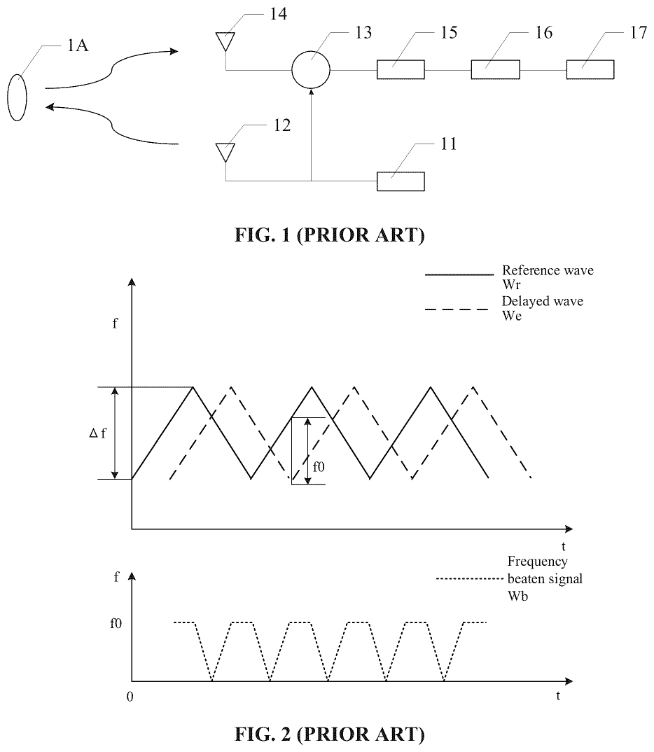

### DETAILED DESCRIPTION

As described in the Background, some existing solutions for correcting and controlling the output frequency of a light source need complex circuit and chip designs, resulting in high system complexity and increased cost.

The existing solutions for correcting and controlling the output frequency of the light source is typically divided into two categories. One is a solution with an Analog Optical Phase-Locked Loop (“AOPLL”), and the other is a solution with a Digital Optical Phase-Locked Loop (“DOPLL”). A core difference between the two solutions is whether a phase detector in the phase-locked loop is in an analog form or a digital form.

However, among the existing phase-locked loop solutions, the analog optical phase-locked loop solution needs many discrete devices for implementation. For example, a gain circuit, an integrating circuit, an adder, a signal generator circuit, or the like are needed. The AOPLL can make the system of AOPLL solution complex and costly. In addition, the discrete devices need to be installed on a Printed Circuit Board (“PCB”) respectively, which can cause a delay problem in electrical signals, thus resulting in slow loop response, making it difficult to meet actual needs. The DOPLL solution can be typically implemented through chips, which needs complex chip design and high manufacturing costs. Moreover, most of functions and logic in the manufactured chips have been fixed, which is inconvenient in debugging and adapting to various needs.

To solve the above problems, light emission control methods for a light source are provided in the embodiments of this disclosure. The optical signal output by the light source can be corrected by performing phase discrimination and comparison on a difference frequency signal determined based on an optical signal output by the light source with a predetermined reference square signal, and performing integrating processing on the phase discrimination result, and superposing the determined integral value and the value of a pre-corrected modulation curve to determine a digital drive signal and then determining an analog drive signal based on the digital drive signal to drive the light source to output the optical signal. In this way, the optical signal output by the light source can be corrected to realize the light emission control of the light source without the need for complicated circuit or chip design. In such a case, the system complexity and implementation costs can be reduced.

To enable those skilled in the art to better understand the principles and advantages of the light emission control method for the light source in the embodiments of this disclosure and implement them, a detailed description is be given below through some embodiments with reference to the accompanying drawings.

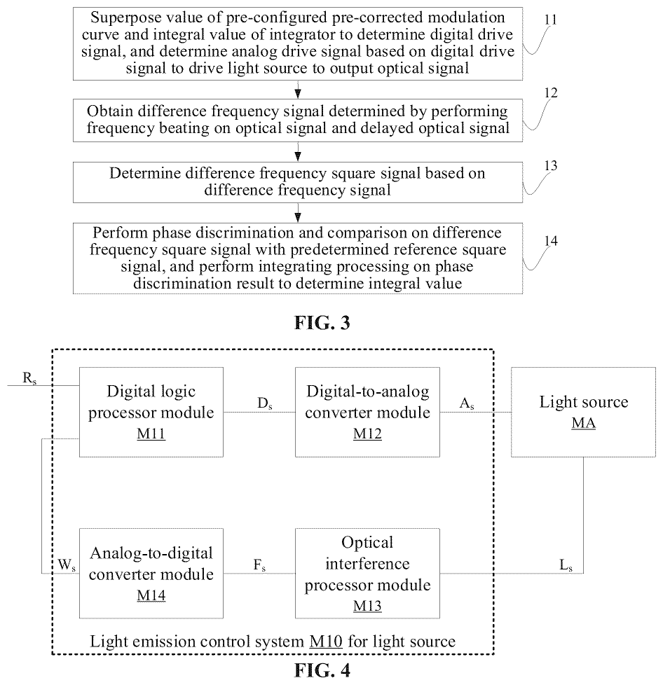

FIG. 3 shows a flowchart of an example light emission control method for a light source, consistent with some embodiments of this disclosure. In some embodiments of this disclosure, light emission control can be performed on the light source based on the following steps.

At S11, a value of a pre-configured pre-corrected modulation curve and an integral value of an integrator can be superposed to determine a digital drive signal, and an analog drive signal can be determined based on the digital drive signal to drive the light source to output an optical signal.

The pre-corrected modulation curve is configured to control the frequency of the optical signal output by the light source to be consistent with a target frequency.

In some embodiments of this disclosure, the pre-corrected modulation curve is configured to enable the light source to output a linear frequency modulated optical signal. It is understandable that, based on the needs, the pre-corrected modulation curve can also be configured to enable the light source to output a nonlinear frequency modulated optical signal that meets predetermined needs, and the embodiments of this disclosure do not impose any restrictions on the shape and specific value of the pre-corrected modulation curve.

At S12, a difference frequency signal determined by performing frequency beating on the optical signal and a delayed optical signal can be obtained.

Through step S11, the generated analog drive signal can drive the light source to output the optical signal. In such a case, the difference frequency signal determined by performing frequency beating on an optical signal with a particular delay and the optical signal can be obtained.

In some embodiments, a difference frequency optical signal determined by performing frequency beating on the optical signal and the delayed optical signal can be first obtained, and then a difference frequency voltage signal can be determined based on the difference frequency optical signal.

In some embodiments, a part of the optical signal output by the light source can be selected for signal detection and light emission control. In such a case, for the optical signal output by the light source, an optical splitter can be used to divide the optical signal into detection light and signal light. The signal light can be used for coherent detection to determine the distance and speed of the object. The detection light can be further divided into two parts, one part can be used as a reference optical signal (e.g., reference wave), and the other part can be delayed and used as a delayed optical signal (e.g., delayed wave), and then frequency beating can be performed on the reference optical signal and the delayed optical signal to generate the difference frequency signal (e.g., the difference frequency voltage signal.)

In some embodiments of this disclosure, a device with a photoelectric conversion function can be used to determine the difference frequency voltage signal based on the difference frequency optical signal. For example, a Photon Detector (“PD”) can be used to determine a difference frequency electrical signal based on the difference frequency optical signal. For another example, the PD can be used to determine a difference frequency current signal based on the difference frequency optical signal. After that, a Trans-Impedance Amplifier (“TIA”) can be used to amplify the determined difference frequency current signal, and the difference frequency voltage signal can be determined based on the amplified difference frequency current signal.

In some embodiments, a device such as a photoelectric converter and a photodiode can determine the difference frequency voltage signal based on the difference frequency optical signal.

At S13, a difference frequency square signal can be determined based on the difference frequency signal.

In some embodiments, the determined difference frequency signal can be an analog signal. So the waveform can be unstable, and the amplitude and phase at different time points can be greatly different. When the difference frequency signal is directly used to determine whether the optical signal output by the light source meets the target needs, complex calculations can be needed. To reduce this problem, signal conversion can be performed on the difference frequency signal, and a difference frequency square signal with relatively stable amplitude and phase can be determined. In such a case, the difficulty in phase discrimination and comparison can be reduced.

At S14, the phase discrimination and comparison can be performed on the difference frequency square signal with a predetermined reference square signal, and integrating processing can be performed on the phase discrimination result to determine the integral value.

In some embodiments, the light source can output the optical signal based on the analog drive signal determined by the pre-corrected modulation curve. When the optical signal is interfered, the difference frequency square signal determined through steps S11 to S13 can generate a deviation from the reference square signal, and by performing phase discrimination and comparison on the difference frequency square signal with the reference square signal, the corresponding phase discrimination result can be determined. Integrating processing can be then performed on the phase discrimination result, and the integral value can be determined. By superposing the integral value and the value of the pre-configured pre-corrected modulation curve, a corrected drive signal can be determined. By using the corrected drive signal, the optical signal output by the light source can be corrected to realize light emission control of the light source.

In some embodiments, based on the needs of the application scenario, to enable the light source to output linear frequency modulated light, the value of the pre-corrected modulation curve can be used to enable the light source to output a linear frequency modulated optical signal, and the light source can output an optical signal based on an analog drive signal determined by the value of the pre-corrected modulation curve. When the optical signal deviates from linear frequency modulation, the optical signal and the delayed optical signal can be mixed to generate the difference frequency signal. The integral value can be determined based on the frequency difference between the difference frequency signal and the predetermined reference square signal. The integral value can be used to change the value of the pre-corrected modulation curve to enable the light source to output the linear frequency modulated optical signal that meets the predetermined needs.

For example, when the integral value is zero, it can indicate that the frequency of the difference frequency square signal is equal to the frequency of the predetermined reference square signal, and the light source can output a linear frequency modulated optical signal that meets the predetermined needs. When the integral value is not zero, by superposing the integral value to the value of the pre-configured pre-corrected modulation curve, the intensity of the determined digital drive signal can be changed to enable the frequency of the difference frequency square signal to be equal to the frequency of the predetermined reference square signal. In such a case, the light source can be controlled to be corrected and output a linear frequency modulated optical signal that meets the predetermined needs, even in an event of interference.

As described, the phase discrimination and comparison can be performed on the difference frequency signal determined based on the optical signal output by the light source with the predetermined reference square signal, and the integrating processing can be then performed on the phase discrimination result, and the determined integral value and the value of the pre-corrected modulation curve can be superposed, and then the corrected digital drive signal can be determined. The analog drive signal can be determined based on the digital drive signal and can drive the light source to output the frequency modulated optical signal that meets the predetermined needs. In this way, the optical signal output by the light source can be corrected to realize the light emission control of the light source without complicated circuit or chip design. In such a case, the system complexity and implementation costs can be reduced.

In some embodiments, the phase discrimination and comparison can be performed on the difference frequency signal with the predetermined reference square signal. For example, to reduce the difficulty of the phase discrimination and comparison, before performing the phase discrimination and comparison, a difference frequency square signal can be determined based on the difference frequency voltage signal. In such a case, determination about whether there is a deviation in the frequencies of rising edges and falling edges of the difference frequency voltage signal and the predetermined reference square signal during the phase discrimination and comparison can be facilitated.

In some embodiments, the difference frequency square signal can be determined based on the difference frequency signal in various ways. For example, the difference frequency square signal can be determined directly based on the difference frequency voltage signal. For another example, the difference frequency square signal can be determined through multiple transformations and processes. For yet another example, signal collection can be performed on the difference frequency voltage signal first, and then the difference frequency square signal can be determined based on the difference frequency voltage signal.

In some embodiments of this disclosure, the difference frequency square signal can be determined based on the difference frequency voltage signal in at least one of the following ways.

On a first approach, the difference frequency voltage signal can be collected by using an analog-to-digital converter to determine a difference frequency voltage digital signal. A comparator can compare the difference frequency voltage digital signal with a predetermined reference value and output the difference frequency square signal.

On a second approach, the difference frequency square signal can be determined based on the difference frequency voltage signal by using a Schmitt trigger.

After that, phase discrimination and comparison can be performed on the determined difference frequency square signal with the predetermined reference square signal, and integrating processing can be performed on the phase discrimination result to determine the integral value. By superposing the integral value and the value of the pre-configured pre-corrected modulation curve, the intensity of the corrected drive signal can be determined. In such a case, the light source can be driven to output the optical signal that meets the predetermined needs (e.g., to output a linear frequency modulated optical signal.)

Accordingly, this disclosure further provides light emission control systems corresponding to the light emission control methods for a light source.

FIG. 4 shows a schematic structural diagram of an example light emission control system for a light source, consistent with some embodiments of this disclosure. In some embodiments of this disclosure, with reference to FIG. 4, the light emission control system M10 for a light source is coupled to a light source MA. The light emission control system M10 for a light source includes: an optical interference processor module M13, a digital-to-analog converter module M12, a digital logic processor module M11, and an analog-to-digital converter module M14.

The digital-to-analog converter module M12 can determine an analog drive signal As based on a digital drive signal Ds output by the digital logic processor module M11 to drive the light source to output an optical signal Ls.

The optical interference processor module M13 can delay the optical signal Ls, and perform frequency beating on the optical signal Ls and the delayed optical signal to determine a difference frequency signal Fs.

The analog-to-digital converter module M14 can determine a difference frequency square signal Ws based on the difference frequency signal Fs.

The digital logic processor module M11 can superpose a pre-configured pre-corrected modulation curve and an integral value of an integrator to determine the digital drive signal Ds, and perform phase discrimination and comparison on the difference frequency square signal Ws with a predetermined reference square signal Rs, and perform integrating processing on the phase discrimination result to determine the integral value.

The pre-corrected modulation curve can be configured to control the frequency of the optical signal output by the light source to be consistent with a target frequency.

In some embodiments of this disclosure, the pre-corrected modulation curve is configured to enable the light source to output a linear frequency modulated optical signal. It is understandable that, based on the needs, the pre-corrected modulation curve can also be configured to enable the light source to output a nonlinear frequency modulated optical signal that meets predetermined needs, and the embodiments of this disclosure do not impose any restrictions on the shape and specific value of the pre-corrected modulation curve.

The working principle of the light emission control system M10 for a light source is described below with reference to FIG. 4.

First, the digital logic processor module M11 can output the digital drive signal Ds based on the value of the pre-configured pre-corrected modulation curve, and output the determined digital drive signal Ds to the digital-to-analog converter module M12. The digital-to-analog converter module M12 can determine the corresponding analog drive signal As based on the digital drive signal Ds. Driven by the analog drive signal As, the light source MA can output the optical signal Ls.

The optical interference processor module M13 can perform delay processing on the optical signal Ls output by the light source MA, and perform frequency beating processing on the delayed optical signal and the optical signal Ls to determine the corresponding difference frequency signal Fs. Then, the corresponding difference frequency signal Fs can be outputted to the analog-to-digital converter module M14. The analog-to-digital converter module M14 can determine the difference frequency square signal Ws based on the difference frequency signal Fs and outputs it to the digital logic processor module M11.

Furthermore, the digital logic processor module M11 can perform phase discrimination and comparison on the difference frequency square signal Ws with the predetermined reference square signal Rs, and perform integrating processing on the determined phase discrimination result to determine an integral value, and superpose the integral value and the value of the pre-configured pre-corrected modulation curve to determine the corrected digital drive signal Ds and the analog drive signal As.

It can be seen from the above working principle, as the optical signal output by the light source MA changes, the difference frequency signal determined based on the optical signal also changes, and then the determined integral value changes accordingly. Superposing the integral value and the value of the pre-corrected modulation curve can realize the control of the drive signal for the light source MA, and the optical signal Ls output by the light source MA can be corrected to enable the light source MA to output an optical signal that meets the predetermined needs, thus realizing the light emission control of the light source MA.

Using the above light emission control system M10 for a light source, the optical signal output by the light source can be corrected by doing the following steps through the digital logic processor module M11. The steps includes performing phase discrimination and comparison on the difference frequency signal determined based on the optical signal output by the light source MA with the predetermined reference square signal, and performing integrating processing on the phase discrimination result, and superposing the determined integral value and the value of the pre-corrected modulation curve. In this way, the optical signal output by the light source can be corrected to realize the light emission control of the light source without the need for complicated circuit or chip design, thus reducing the system complexity and further reducing implementation costs.

To facilitate clearer understanding and implementation of those skilled in the art, some implementable examples of various modules in the light emission control system for a light source in some embodiments of this disclosure are shown below.

In some embodiments, the digital logic processor module can be a circuit with logic control or a chip or module integrated by multiple devices.

In some embodiments of this disclosure, the digital logic processor module can be a programmable logic device. As an example, the digital logic processor module can be a Field-Programmable Gate Array (“FPGA”), in which multiple electronic components can be integrated to achieve correction of an optical signal output by a light source. Because the FPGA can be customized and programmed to design its functions and logic instead of being fixed, it is easy to debug and adapt to different needs based on application scenarios, and thus the implementation costs of the light emission control system can be reduced.

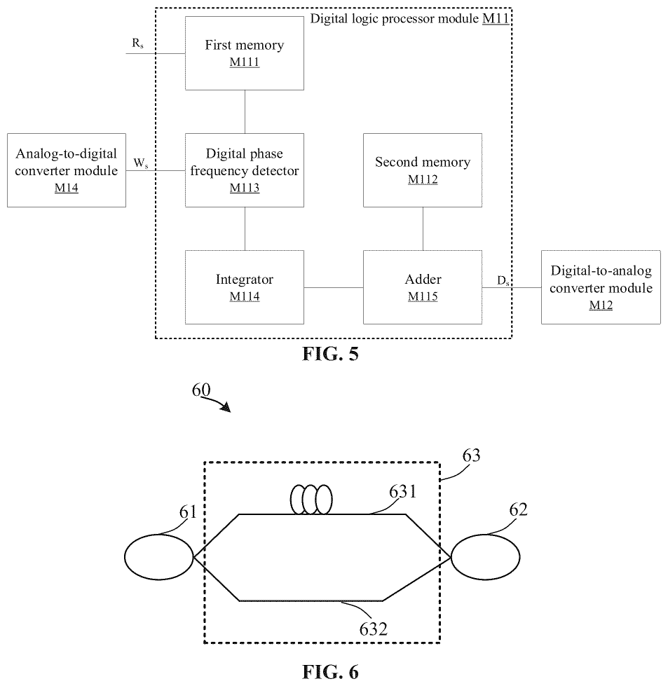

FIG. 5 shows a schematic structural diagram of an example digital logic processor module, consistent with some embodiments of this disclosure. With reference to FIG. 5, the digital logic processor module M11 is coupled to the digital-to-analog converter module M12 and the analog-to-digital converter module M14. The digital logic processor module M11 can include: a first memory M111, a second memory M112, a digital phase frequency detector M113, an integrator M114, and an adder M115.

The first memory M111 is configured to store the reference square signal Rs.

The second memory M112 is configured to store the pre-corrected modulation curve of the light source.

The digital phase frequency detector M113 is configured to perform phase discrimination and comparison on the difference frequency square signal Ws with the reference square signal Rs stored in the first memory M111, and output the phase discrimination result.

The integrator M114 is configured to perform integrating processing on the phase discrimination result output by the digital phase frequency detector M113 to determine an integral value.

The adder M115 is configured to superpose the integral value and a value of the pre-corrected modulation curve stored in the second memory M112 to determine the digital drive signal Ds.

In some embodiments, when the digital logic processor module M11 works, the digital phase frequency detector M113 can perform phase discrimination and comparison on the reference square signal Rs stored in the first memory M111 with the difference frequency square signal Ws output by the analog-to-digital converter module M14, and output the determined phase discrimination result to the integrator M114. The integrator M114 can perform integrating processing on the phase discrimination result to determine the corresponding integral value. The adder M115 can superpose the integral value and the value of the pre-corrected modulation curve stored in the second memory M112 to determine the corrected digital drive signal Ds, and output the digital drive signal Ds to the digital-to-analog converter module M12, to drive the light source to output the optical signal.

It can be seen from the above embodiments, by using the digital logic processor module including the first memory, the second memory, the integrator, the adder, and the digital phase frequency detector, on the one hand, the volume of the light emission control system for the light source can be reduced; and on the other hand, the time delay between signals of various devices can be reduced and the response speed of the light emission control system for the light source can be improved.

In some embodiments, different types and specifications of light sources can be selected based on the different application scenarios and needs of the light source. Accordingly, different predetermined pre-corrected modulation curves can be stored in the second memory. Or the second memory can include multiple storage units inside, and each storage unit can store a different pre-corrected modulation curve to be applicable to different application scenarios.

It should be noted that the structure of the digital logic processor module in the above embodiments is only an example illustration, and the embodiments of this disclosure are not intended to limit the specific structure of the digital logic processor module. For example, in some optional examples, the first memory and the second memory can be placed outside the digital logic processor module. Or, the first memory and the second memory can be integrated together, and use a unified memory to store corresponding data.

In some embodiments, the optical interference module can output a difference frequency optical signal. A corresponding difference frequency electrical signal (which can be referred to as a difference frequency signal) can be determined based on the difference frequency optical signal determined by performing frequency beating processing, and then the determined difference frequency signal can be input to the analog-to-digital converter module.

In some embodiments of this specification, to achieve photoelectric signal conversion, the light emission control system for a light source can also include: a photon detector module, configured to receive the difference frequency optical signal output by the optical interference processor module, and determine the difference frequency voltage signal based on the difference frequency optical signal.

For example, the photon detector module can be coupled between the optical interference processor module and the analog-to-digital converter module, and the photon detector module can include: a photon detector and a trans-impedance amplifier.

The photon detector can be configured to determine a difference frequency current signal based on the difference frequency optical signal.

The trans-impedance amplifier can be configured to perform signal amplification processing on the difference frequency current signal and determine the difference frequency voltage signal based on the difference frequency current signal.

The photon detector module in the above embodiment is used. The photon detector can detect the difference frequency optical signal output by the optical interference processor module, and determine a difference frequency current signal based on the difference frequency optical signal. The photon detector can output the difference frequency current signal to a trans-impedance amplifier coupled thereto. The difference frequency current signal can flow through the trans-impedance amplifier. On the one hand, the difference frequency current signal can be amplified. And on the other hand, the difference frequency voltage signal can be determined based on the difference frequency current signal. In such a case, the difference frequency voltage signal can be determined, and the difference frequency voltage signal determined after passing through the trans-impedance amplifier can have a larger amplitude and can be easier to identified and processed.

It is understandable that the structure of the above photon detector module is an example illustration and is not used to limit the structure of the photon detector module. In some embodiments, photon detector modules or devices with other structures can also be used to determine the difference frequency voltage signal based on the difference frequency optical signal. For example, the photon detector module can also be a module or device with photoelectric detection and conversion functions such as a photoelectric converter or a photodiode.

In some embodiments, the determined difference frequency voltage signal can be an analog signal. When the difference frequency voltage signal is interfered, the waveform can be unstable, and the amplitude and phase at different time points can be greatly different. In such a case, if phase discrimination and comparison is directly performed on the difference frequency voltage signal with the reference square signal, the phase discrimination and comparison process needs a large amount of calculation, and occupies a lot of system resources. To reduce this problem, after the difference frequency voltage signal is determined, a difference frequency square signal with a relatively stable waveform can be determined based on the difference frequency voltage signal.

In some embodiments of this disclosure, the analog-to-digital converter module can be used to determine the difference frequency square signal based on the difference frequency voltage signal.

For example, the analog-to-digital converter module can include: an analog-to-digital converter and a comparator. The analog-to-digital converter can be configured to collect the difference frequency voltage signal to determine a difference frequency voltage digital signal. The comparator can be configured to compare the difference frequency voltage digital signal with a predetermined reference value and output the difference frequency square signal.

In some embodiments, to further reduce the volume of the entire light emission control system for a light source, reduce the time delay between the signals of various devices, and improve the response speed of the light emission control system for a light source, some or all of the devices that generate the difference frequency square signal can be built into the digital logic processor module. For example, the analog-to-digital converter together with the comparator can be built into the digital logic processor module. For another example, the comparator can be built into the digital logic processor module alone.

For example, the analog-to-digital converter module can include an analog-to-digital converter. The analog-to-digital converter can be configured to collect the difference frequency voltage signal to determine a difference frequency voltage digital signal. Accordingly, the digital logic processor module can further include a comparator, configured to compare the difference frequency voltage digital signal with a predetermined reference value and output the difference frequency square signal.

In some embodiments, the difference frequency square signal can be determined based on the difference frequency voltage signal directly without multiple conversions, thereby reducing the delay between the signals of various devices in the system and improving the response speed of the system, and further reducing the volume of the entire light emission control system. In another example of this disclosure, the analog-to-digital converter module can include a Schmitt trigger configured to determine the difference frequency square signal based on the difference frequency voltage signal.

It is understandable that the structure of the above analog-to-digital converter module is only an example. In some embodiments, the difference frequency square signal can be determined based on the difference frequency voltage signal by circuits in other forms.

In some embodiments, the light source can be any device capable of emitting light. In an example of this disclosure, the light source can be a Distributed Feedback Laser (“DFB”). The distributed feedback laser can be used on a LiDAR to detect distances and speeds of surrounding targets.

In some embodiments, to reduce the energy consumption of the light emission control system, an optical splitter can be used to divide the optical signal output from the light source into detection light and signal light. The signal light can be used to calculate the distance and speed of a target. The detection light can be used to detect whether the optical signal meets linear sweep-frequency. When the optical signal deviates from the linear sweep-frequency, the light source drive signal can be corrected by the light emission control method for a light source of the embodiments of this disclosure.

In some embodiments of this disclosure, a variety of different forms of interferometers can be used to process the output optical signal to determine the difference frequency signal. In some embodiments, the optical interference processor module can be a fiber interferometer with unequal arm lengths, for example, the fiber interferometer with unequal arm lengths can be a Mach-Zehnder interferometer.

FIG. 6 shows a schematic structural diagram of an example optical interference processor module, consistent with some embodiments of this disclosure. With reference to FIG. 6, the fiber interferometer 60 with unequal arm lengths can include two couplers 61 and 62, and an interference unit 63 with unequal arm lengths coupled between the coupler 61 and the coupler 62. The interference unit 63 with unequal arm lengths can include two waveguide arms 631 and 632, and the waveguide arm 631 and the waveguide arm 632 have different lengths.

When the light source outputs an optical signal to the coupler 61, the optical signal can be divided into two optical signals by the coupler 61. One optical signal enters the waveguide arm 631 and the other optical signal enters the waveguide arm 632. The length of the waveguide arm 631 is longer than the length of the waveguide arm 632, and in such a case, the optical signal located at the waveguide arm 631 can be delayed, resulting in an optical path difference (i.e., a phase difference) between the two optical signals. When the two optical signals reach the coupler 62, the two optical signals can be combined into one beam and output. Due to the existence of the optical path difference, frequency beating can occur at the coupler 62 from the two optical signals to determine the corresponding difference frequency signal.

To enable those skilled in the art to better understand and implement the working principle of the light emission control system for a light source in the embodiments of this disclosure, a detailed description is given below through example application scenarios with reference to the accompanying drawings.

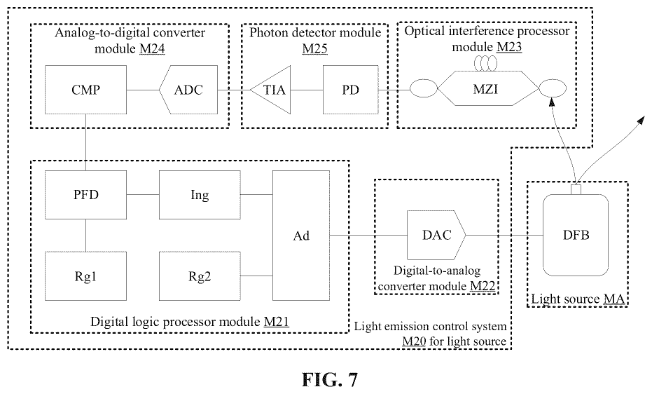

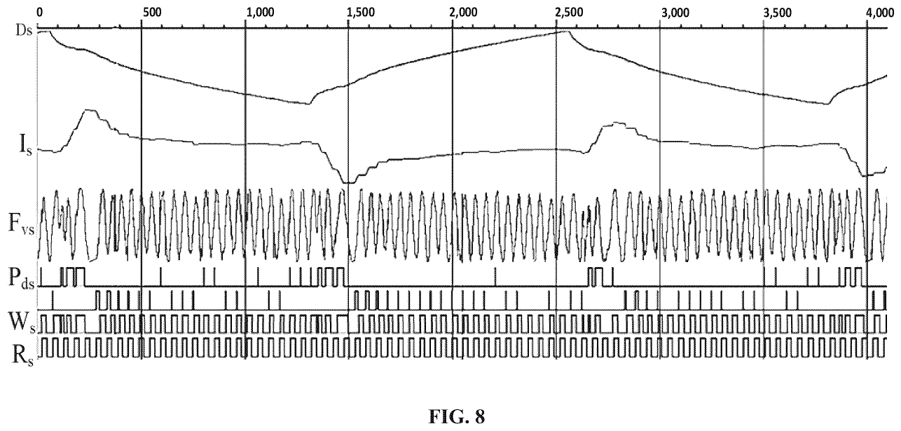

FIG. 7 shows a schematic structural diagram of a first example light emission control system for a light source, consistent with some embodiments of this disclosure. With reference to FIG. 7, a light emission control system M20 for a light source is coupled to a light source MA and is configured to detect an optical signal output by the light source MA, and perform corresponding feedback control based on the detection result.

Similar to the above embodiments, the light emission control system M20 for a light source can include a digital logic processor module M21, a digital-to-analog converter module M22, an optical interference processor module M23, and an analog-to-digital converter module M24, and optionally can also include an optical detector module M25.

In some embodiments of this disclosure, with reference to FIG. 7, the digital logic processor module M21 can include a first memory Rg1, a second memory Rg2, a digital phase frequency detector PFD, an integrator Ing, and an adder Ad. For the functions and effects of various devices, reference can be made to the detailed description of the digital logic processor module M11 in the embodiments, and are not described in detail hereafter.

As an optional example, the digital-to-analog converter module M22 can be a digital-to-analog converter DAC.

As an optional example, the light source MA can be a distributed feedback laser DFB, or a laser of another type, or a light emitting diode, or the like.

As an optional example, the optical interference processor module M23 can be a Mach-Zehnder interferometer MZI.

As an optional example, the analog-to-digital converter module M24 can include an analog-to-digital converter ADC and a comparator CMP.

As an optional example, the optical detector module M25 can include a photon detector PD and a trans-impedance amplifier TIA.

The light emitted by the light source MA can pass through one or multiple optical splitters (not shown in the figure), and part of the light can be separated as detection light, which can be coupled and received by the optical interference processor module M23.

The working principle of the above light emission control system M20 for a light source is described below.

When the light emission control system M20 for a light source starts working, an integral value of the integrator Ing can be zero, and the digital logic processor module M21 can generate a digital drive signal based on a value of a pre-corrected modulation curve pre-stored in the second memory Rg2, and output the digital drive signal to the digital-to-analog converter DAC.

The digital-to-analog converter DAC can determine a corresponding analog drive signal based on the digital drive signal, and output the analog drive signal to the distributed feedback laser DFB. Driven by the analog drive signal, the distributed feedback laser DFB can emit light and output an optical signal. A part of the optical signal (as indicated by an arrow in the figure) enters a Mach-Zehnder interferometer MZI. An optical splitter (not shown in FIG. 7) can be used to split the optical signal output by the distributed feedback laser DFB to determine the part of the optical signal.

The Mach-Zehnder interferometer MZI can delay the incoming optical signal, and perform frequency beating processing on the optical signal and the delayed optical signal internally to determine a difference frequency optical signal and output the difference frequency optical signal to the photon detector PD. The working principle of the Mach-Zehnder interferometer MZI can be determined with reference to FIG. 6 and its corresponding description.

The photon detector PD can determine a difference frequency current signal based on the detected difference frequency optical signal and outputs the difference frequency current signal to the trans-impedance amplifier TIA coupled thereto. Under the action of the trans-impedance amplifier TIA, the difference frequency current signal can be amplified, a difference frequency voltage signal can be determined based on the amplified difference frequency current signal, and the determined difference frequency voltage signal can be outputted to the analog-to-digital converter ADC.

The analog-to-digital converter ADC can determine a difference frequency voltage digital signal based on the difference frequency voltage signal and output the difference frequency voltage digital signal to the comparator CMP. The comparator CMP, by comparing a predetermined reference value with the difference frequency voltage digital signal, can output a difference frequency square signal to the digital phase frequency detector PFD.

The digital phase frequency detector PFD can perform phase discrimination and comparison on a reference square signal stored in the first memory Rg1 and the difference frequency square signal output by the comparator CMP, and output a corresponding phase discrimination result to the integrator Ing. The integrator Ing can perform integrating processing on the phase discrimination result to determine an integral value. The integral value can be superposed to a value of the pre-corrected modulation curve stored in the second memory Rg2 to change the digital drive signal outputted to the digital-to-analog converter DAC. The analog drive signal that drives the distributed feedback laser DFB can be changed. In such a case, light emission control of the light source can be achieved.

In some embodiments, to enable the light source to output linear frequency modulated light, the value of the pre-corrected modulation curve can be used to enable the light source to output a linear frequency modulated optical signal.

After the detection and feedback control process performed on the optical signal, when the integral value is zero, it can indicate that the frequency of the difference frequency square signal is equal to the frequency of the predetermined reference square signal, and the light source can output a linear frequency modulated optical signal that meets predetermined needs. When the integral value is not zero, by superposing the integral value to the value of the pre-configured pre-corrected modulation curve, the size of the determined digital drive signal can be changed. In such a case, the light source can be controlled to output the linear frequency modulated optical signal that meets the predetermined needs.

Waveform changes of various signals during the correction process of the optical signal output by the light source are described in detail below with reference to FIG. 8.

FIG. 8 shows an example waveform diagram of a corresponding output signal of FIG. 7, consistent with some embodiments of this disclosure. With reference to FIG. 8, the difference frequency voltage signal Fvs collected by the analog-to-digital converter ADC with large amplitude fluctuation can be converted by the comparator to generate a difference frequency square signal Ws. After phase discrimination is performed on the difference frequency square signal Ws and the predetermined reference square signal Rs by the phase frequency detector, a phase-discriminated signals Pds of the difference frequency square signal Ws and the predetermined reference square signal can be determined. If the phase-discriminated signal Pds is not zero, it can indicate that the optical signal deviates from the linear sweep-frequency. The pulse width of the phase-discriminated signal Pds can reflect the magnitude of the frequency deviation of the optical signal. After the phase-discriminated signal Pds is integrated by the integrator, a determined integrated signal Is can be superposed to the pre-configured pre-corrected modulation signal (not shown in FIG. 8) to determine the digital drive signal Ds. An analog drive signal (not shown in FIG. 8) can be further determined based on the digital drive signal Ds, and the analog drive signal can be used to change the optical signal output by the light source, for example, a parameter such as the frequency of the optical signal.

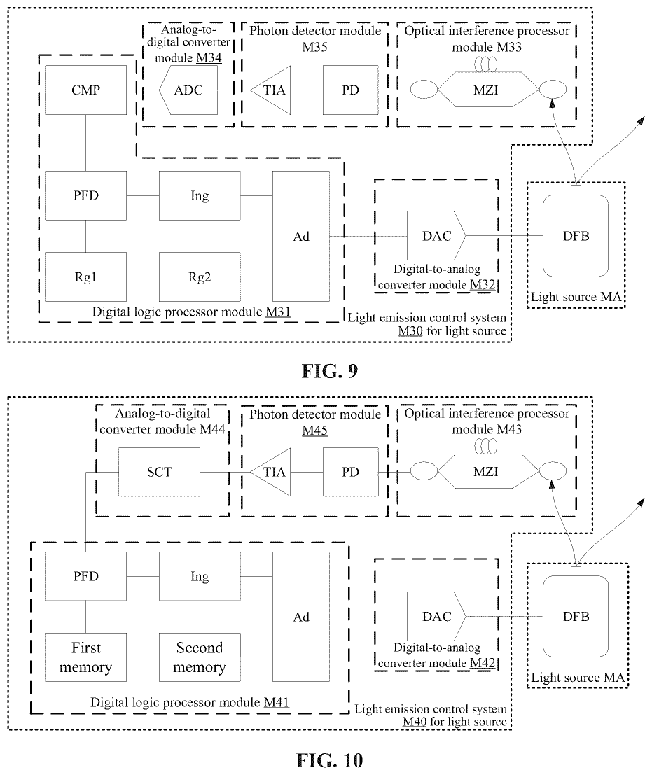

As mentioned above, the digital logic processor module can be a programmable logic device. In some embodiments, the comparator can also be integrated into the digital logic processor module to further improve system integration and reduce the volume of the entire light emission control system and signal delay between different components. FIG. 9 shows a schematic structural diagram of a second example light emission control system for a light source, consistent with some embodiments of this disclosure. For example, with reference to FIGS. 7 and 9, the difference between the light emission control system M30 and the light emission control system M20 is that the comparator CMP in the light emission control system M30 is built in the digital logic processor module M31.

For the functions, working principles, and correction processes of other modules in the light emission control system M30 for a light source, reference can be made to the corresponding description of the light emission control system M20 for a light source shown in FIG. 7, and they are not described here.

In some embodiments, to reduce the quantity of components and the number of signal conversions, a difference frequency square signal can be determined directly based on the difference frequency voltage signal. FIG. 10 shows a schematic structural diagram of a third example light emission control system for a light source, consistent with some in embodiments of this disclosure. For example, with reference to FIGS. 7 and 10, the difference between a light emission control system M40 for a light source and the light emission control system M20 for a light source in FIG. 7 is that the light emission control system M40 for a light source uses a Schmitt trigger SCT to determine a square voltage signal directly based on the difference frequency voltage signal output by the trans-impedance amplifier TIA. In such a case, the analog-to-digital converter ADC and the comparator CMP in FIG. 7 can be replaced.

For descriptions of the functions, working principles, and correction processes of other modules in the light emission control system M40 for a light source, reference can be made to the corresponding description of the light emission control system M20 for a light source shown in FIG. 7, and they are not described here.

The embodiments of this disclosure further provides another light emission control system for a light source. A difference from the light emission control system for a light source in the embodiments is that the light emission control system for a light source in the embodiments integrates the first memory, the second memory, the digital phase frequency detector, the integrator, and the adder in the digital logic processor module, and in other embodiments of this disclosure, the first memory, the second memory, the digital phase frequency detector, the integrator, and the adder can also be arranged separately.

FIG. 11 shows a schematic structural diagram of a third light emission control system for a light source, consistent with some embodiments of this disclosure. In some embodiments of this disclosure, with reference to FIG. 11, the light emission control system M50 for a light source is coupled to the light source. The light emission control system M50 for the light source includes an integrator M51, an adder M52, a second memory M53, a digital-to-analog converter module M54, an optical interference processor module M55, an analog-to-digital converter module M56, a digital phase frequency detector M57, and a first memory M58.

The digital-to-analog converter module M54 can determine an analog drive signal based on a digital drive signal output by the adder M55 to drive the light source MA to output an optical signal.

The optical interference processor module M55 can perform frequency beating on the optical signal and a delayed optical signal to determine a difference frequency signal.

The analog-to-digital converter module M56 can determine a difference frequency square signal based on the difference frequency signal.

The first memory M58 can store a reference square signal.

The second memory M53 can store a pre-corrected modulation curve of the light source.

The digital phase frequency detector M57 can perform phase discrimination and comparison on the difference frequency square signal with the reference square signal stored in the first memory M58, and output a phase discrimination result.

The integrator M51 can perform integrating processing on the phase discrimination result output by the digital phase frequency detector M57 to determine an integral value.

The adder M52 can superpose a value of the pre-corrected modulation curve pre-configured by the second memory M53 and the integral value to determine the digital drive signal.

In some embodiments of this disclosure, the pre-corrected modulation curve can enable the light source to output a linear frequency modulated optical signal.

The working principle of the light emission control system M50 for a light source is described below with reference to FIG. 11.

When the light emission control system M50 for a light source starts working, the integral value in the integrator M51 can be zero, and the adder M52 can store the value of the pre-corrected modulation curve of the light source MA in the second memory M53 to generate the digital drive signal and output the digital drive signal to the digital-to-analog converter module M54. The digital-to-analog converter module M54 can determine an analog drive signal based on the digital drive signal to drive the light source MA to emit light. The optical interference processor module M55 can perform frequency beating processing on the optical signal output by the light source MA, and determine a difference frequency signal, and outputs the difference frequency signal to the analog-to-digital converter module M56. The analog-to-digital converter module M56 can determine a difference frequency square signal based on the difference frequency signal, and outputs the difference frequency square signal to the digital phase frequency detector M57. The digital phase frequency detector M57 can perform phase discrimination and comparison on the reference square signal stored in the first memory M58 with the difference frequency square signal. The determined phase discrimination result can be integrated by the integrator M51 to determine the integral value. By superposing the integral value to the value of the pre-configured pre-corrected modulation curve through the adder M52, the value of the pre-corrected modulation curve can be changed to determine a corrected drive signal. In such a case, light emission control of the light source can be achieved.

In some embodiments, the optical interference module can output a difference frequency optical signal, and the analog-to-digital converter module cannot identify the difference frequency optical signal output by the optical interference module. In such a case, a corresponding difference frequency electrical signal can be determined based on the difference frequency optical signal determined by frequency beating processing, and then the determined difference frequency electrical signal can be input to the analog-to-digital converter module for analog-to-digital conversion processing.

In some embodiments, with continued reference to FIG. 11, the light emission control system M50 for a light source can further include a photon detector module M59. The photon detector module M59 can be coupled between the optical interference processor module M55 and the analog-to-digital converter M56. The photon detector module M59 can receive the difference frequency optical signal output by the optical interference processor module M55, and determine a difference frequency voltage signal based on the difference frequency optical signal.

For the detailed composition, functions, and working principles of various modules of the light emission control system for a light source, reference can be made to the embodiments, and they are not described herein.

In some embodiments, the light emission control system for a light source described in any of the embodiments can be applied to an apparatus or a device that needs to effectively control the output light of the light source. For example, it can be applied to situations and corresponding devices in which light emission control is performed on a laser, and some example applications in a LiDAR are provided below.

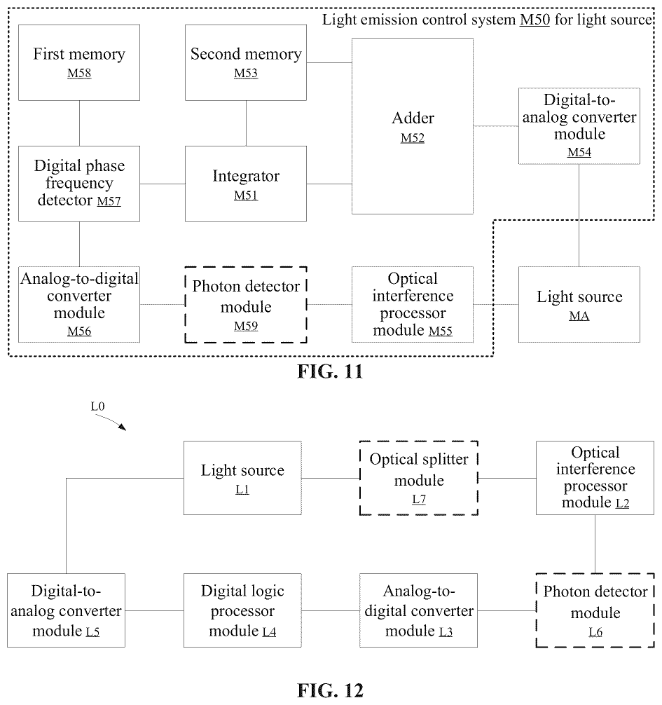

FIG. 12 shows a schematic structural diagram of a first example LiDAR, consistent with some embodiments of this disclosure. With reference to FIG. 12, a LiDAR L0 can include a light source L1, an optical interference processor module L2, an analog-to-digital converter module L3, a digital logic processor module L4, and a digital-to-analog converter module L5.

The light source L1 can output an optical signal.

The digital-to-analog converter module L5 can determine an analog drive signal based on a digital drive signal output by the digital logic processor module L4 to drive the light source L1 to emit light and control an optical signal output by the light source L1.

The optical interference processor module L2 can perform frequency beating processing on the optical signal and a delayed optical signal to determine a difference frequency signal.

The analog-to-digital converter module L3 can determine a difference frequency square signal based on the difference frequency signal.

The digital logic processor module L4 can superpose a value of a pre-configured pre-corrected modulation curve and an integral value to determine the digital drive signal, and perform phase discrimination and comparison on the difference frequency square signal with a predetermined reference square signal, and perform integrating processing on the phase discrimination result to determine the integral value.

The pre-corrected modulation curve can control the frequency of the optical signal output by the light source to be consistent with a target frequency.

In some embodiments of this disclosure, the pre-corrected modulation curve can enable the light source to output a linear frequency modulated optical signal. It is understandable that, based on the needs, the pre-corrected modulation curve can also enable the light source to output a nonlinear frequency modulated optical signal that meets predetermined needs. The embodiments of this disclosure do not impose any restrictions on the shape and value of the pre-corrected modulation curve.

The detailed implementations of the digital-to-analog converter module, the analog-to-digital converter module, the digital logic processor module, and the optical interference processor module can be determined with reference to introductions in the embodiments, and are not described herein.

In some embodiments, the light source can be any component capable of emitting light. In an example of this disclosure, the light source can be a distributed feedback laser. The distributed feedback laser can be used on a LiDAR to detect distances and speeds of surrounding objects.

In some other embodiments, the light source can include an Edge Emitting Laser (“EEL”) or a Vertical-Cavity Surface Emitting Laser (“VCSEL”), or the like, and the type of the laser used is not limited in the embodiments of this disclosure.

The optical interference processor module can use a fiber interferometer with unequal arm lengths. The structure and working principle of the fiber interferometer with unequal arm lengths can be determined with reference to the corresponding description in FIG. 6 and are not described here.

In an example of this disclosure, the fiber interferometer with unequal arm lengths can be a Mach-Zehnder interferometer.

The optical interference module outputs a difference frequency optical signal, but the analog-to-digital converter module cannot identify the difference frequency optical signal output by the optical interference module. In such a case, with continued reference to FIG. 12, a photon detector module L6 can be arranged between the optical interference processor module L3 and the analog-to-digital converter module L4, which can be configured to receive the difference frequency optical signal output by the optical interference processor module L3, and determine a difference frequency voltage signal based on the difference frequency optical signal. For the implementation of the photon detector module L6, reference can be made to the introduction of the photon detector module in the embodiment, and it is not described here.

Still with reference to FIG. 12, the LiDAR L0 can further include an optical splitter module L7. The optical splitter module L7 is arranged between the light source L1 and the photon detector module L6. The optical splitter module L7 can divide the output light of the light source L1 into signal light and detection light. The signal light can be used to calculate the distance and speed of an object, and the detection light can be used to generate a difference frequency signal, such as a difference frequency voltage signal.

The light emission control process of the light source during the operation of the LiDAR is explained in detail below using an example.

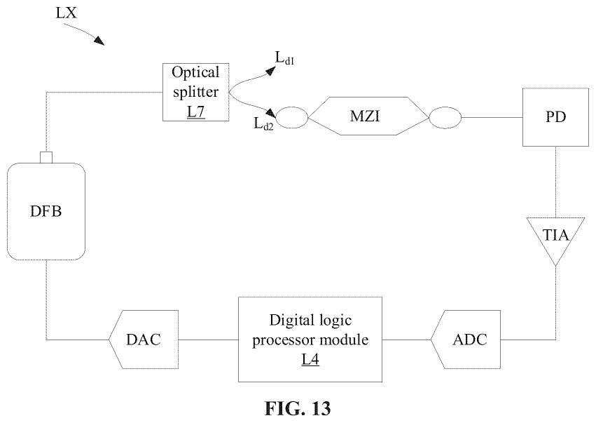

FIG. 13 shows a schematic structural diagram of an example LiDAR, consistent with some embodiments of this disclosure. With reference to FIG. 13, when a LiDAR LX starts working, the light emitted by the distributed feedback laser DFB is split by the optical splitter L7, a part of the light is outputted as signal light Ld1 and used to calculate the distance and speed of a target object, and the other part of the light enters the optical interference processor MZI as detection light Ld2. The optical interference processor MZI can perform frequency beating processing on the detection light Ld2 to determine a difference frequency optical signal. The photon detector PD can determine a difference frequency current signal based on the difference frequency optical signal determined by detection, and output the difference frequency current signal to the trans-impedance amplifier TIA coupled thereto, to determine an amplified difference frequency voltage signal. A difference frequency square signal can be determined based on the difference frequency voltage signal by the analog-to-digital converter ADC. The digital logic processor module L4 can correct the output digital drive signal based on the input difference frequency square signal to determine a corrected digital drive signal and output the corrected digital drive signal to the digital-to-analog converter DAC, to determine an analog drive signal for driving the distributed feedback laser DFB to emit a linear frequency modulation optical signal that meets the predetermined needs.

The digital logic processor module L4 can be provided with corresponding memories to store the pre-corrected modulation curve used for controlling the output light and the reference square signal used for performing phase discrimination and comparison with the difference frequency square signal, and digital logic devices used for correcting the digital drive signal, such as an integrator and an adder. For some optional example structures and correction processes of the digital logic processor module L4, reference can be made to the detailed description of the digital logic processor module in the implementation, and they are not described herein.

In some embodiments, the FPGA can be used in the LiDAR for control of the LiDAR, processing and calculation of detection data, or the like. In some embodiments, a processor module with a linear frequency sweep function (for example, the digital logic processor module described in the embodiment) can be arranged in the FPGA. On the one hand, the remaining computing power of the FPGA can be used. On the other hand, the quantity of the peripheral circuits can be reduced to reduce the implementation cost.

Although the embodiments of this disclosure are disclosed, this disclosure is not limited to the embodiments. Any person skilled in the art can make various alterations and modifications without departing from the spirit and scope of this disclosure. Therefore, the protection scope of this disclosure should be subject to the scope defined by the claims.

What is claimed is:

1. A method of controlling light emission for a light source, comprising:
determining a drive signal for driving the light source to output an optical signal, wherein determining the drive signal comprises superposing a value of a pre-corrected modulation curve and an integral value of an integrator;
determining a difference frequency signal by performing frequency beating on the optical signal and a delayed optical signal; and
updating the integral value by determining phase discrimination data based on the difference frequency signal and a predetermined reference signal, and performing integration on the phase discrimination data.

2. The method of claim 1, wherein determining the difference frequency signal by performing the frequency beating on the optical signal and the delayed optical signal comprises:
determining a difference frequency optical signal by performing the frequency beating on the optical signal and the delayed optical signal; and
determining the difference frequency signal as a difference frequency voltage signal based on the difference frequency optical signal.

3. The method of claim 2, wherein determining the difference frequency square signal based on the difference frequency signal comprises:
determining a difference frequency voltage digital signal in response to receiving the difference frequency voltage signal using an analog-to-digital converter; and
determining the difference frequency square signal in response to comparing the difference frequency voltage digital signal with a predetermined reference value using a comparator.

4. The method of claim 2, wherein determining the difference frequency square signal based on the difference frequency signal comprises:
determining the difference frequency square signal based on the difference frequency voltage signal using a Schmitt trigger.

5. The method of claim 1, wherein the pre-corrected modulation curve is configured to enable the light source to output a linear frequency modulated optical signal.

6. A system of controlling light emission for a light source, the system comprising:
an optical interference processor;
an analog-to-digital converter module;
a digital logic processor; and
a digital-to-analog converter, wherein:
the digital-to-analog converter is configured to determine an analog drive signal based on a digital drive signal output by the digital logic processor for driving the light source to output an optical signal;
the optical interference processor is configured to delay the optical signal and determine a difference frequency signal by performing frequency beating on the optical signal and the delayed optical signal;
the analog-to-digital converter module is configured to determine a difference frequency square signal based on the difference frequency signal; and
the digital logic processor is configured to determine the digital drive signal by superposing a value of a pre-corrected modulation curve and an integral value of an integrator, and update the integral value by determining phase discrimination data based on the difference frequency square signal and a predetermined reference square signal and performing integration on the phase discrimination data.

7. The system of claim 6, wherein the digital logic processor comprises:
a first memory configured to store the reference square signal;
a second memory configured to store the pre-corrected modulation curve of the light source;
a digital phase frequency detector configured to determine the phase discrimination data;
the integrator configured to update the integral value by performing the integration on the phase discrimination data determined by the digital phase frequency detector; and
an adder configured to determine the digital drive signal by superposing the integral value and the value of the pre-corrected modulation curve stored in the second memory.

8. The system of claim 6, wherein the optical interference processor is configured to output a difference frequency optical signal, and the system further comprises:
a photon detector module configured to receive the difference frequency optical signal from the optical interference processor, and determine a difference frequency voltage signal based on the difference frequency optical signal.

9. The system of claim 8, wherein the photon detector module comprises:
a photon detector configured to determine a difference frequency current signal based on the difference frequency optical signal; and
a trans-impedance amplifier configured to amplify the difference frequency current signal and determine the difference frequency voltage signal based on the difference frequency current signal.

10. The system of claim 9, wherein the analog-to-digital converter module comprises:
an analog-to-digital converter configured to determine a difference frequency voltage digital signal in response to receiving the difference frequency voltage signal; and
a comparator configured to determine the difference frequency square signal in response to comparing the difference frequency voltage digital signal with a predetermined reference value.

11. The system of claim 9, wherein the analog-to-digital converter module comprises:
an analog-to-digital converter configured to determine a difference frequency voltage digital signal in response to receiving the difference frequency voltage signal; and
the digital logic processor further comprises:
a comparator configured to determine the difference frequency square signal in response to comparing the difference frequency voltage digital signal with the predetermined reference value.

12. The system of claim 9, wherein the analog-to-digital converter module comprises:
a Schmitt trigger configured to determine the difference frequency square signal based on the difference frequency voltage signal.

13. The system of claim 6, wherein the digital logic processor is a programmable logic device.

14. The system of claim 6, wherein the pre-corrected modulation curve is configured to enable the light source to output a linear frequency modulated optical signal.

15. A system of controlling light emission for a light source, coupled to the light source, and comprising: an optical interference processor module, an analog-to-digital converter module, a first memory, a second memory, a digital phase frequency detector, an integrator, an adder, and a digital-to-analog converter module, wherein:
the digital-to-analog converter module is configured to determine an analog drive signal based on a digital drive signal output by the adder to drive the light source to output an optical signal;
the optical interference processor module is configured to perform frequency beating on the optical signal and a delayed optical signal to determine a difference frequency signal;
the analog-to-digital converter module is configured to determine a difference frequency square signal based on the difference frequency signal;
the first memory is configured to store a reference square signal;
the second memory is configured to store the pre-corrected modulation curve of the light source;
the digital phase frequency detector is configured to perform phase discrimination and comparison on the difference frequency square signal with the reference square signal stored in the first memory, and output a phase discrimination result;
the integrator is configured to perform integrating processing on the phase discrimination result output by the digital phase frequency detector to determine the integral value; and
the adder is configured to superpose a value of the pre-corrected modulation curve pre-configured by the second memory and the integral value to determine the digital drive signal.

16. A LiDAR, comprising:
a light source configured to output an optical signal;
an optical interference processor;
an analog-to-digital converter;
a digital logic processor; and
a digital-to-analog converter, wherein:
the digital-to-analog converter is configured to determine an analog drive signal based on a digital drive signal output by the digital logic processor module;
the optical interference processor is configured to determine a difference frequency signal by performing frequency beating on the optical signal and a delayed optical signal;
the analog-to-digital converter is configured to determine a difference frequency square signal based on the difference frequency signal; and
the digital logic processor is configured to determine the digital drive signal by superposing a value of a pre-corrected modulation curve and an integral value, and update the integral value by determining phase discrimination data based on the difference frequency square signal and a predetermined reference square signal and performing integration on the phase discrimination data.

17. The LiDAR of claim 16, wherein the light source comprises a distributed feedback laser.

18. The LiDAR of claim 16, wherein the optical interference processor comprises a fiber interferometer with unequal arm lengths.

19. The method of claim 1, wherein determining the drive signal for driving the light source to output the optical signal comprises:
determining a digital drive signal by superposing the value of the pre-configured, pre-corrected modulation curve and the integral value; and
determining the drive signal as an analog drive signal based on the digital drive signal.

20. The method of claim 1, wherein updating the integral value comprises
determining a difference frequency square signal based on the difference frequency signal; and
determining the phase discrimination data based on the difference frequency square signal and a predetermined reference square signal.
